(19) United States
(12) Patent Application Publication
(10) Pub. No.: US 2014/0150612 A1
(43) Pub. Date: Jun. 5, 2014

(54) TAMPER RESISTANT SECURITY FASTENER SYSTEM

(71) Applicant: Best Bolt Products, Inc., (US)

(72) Inventor: Larry D. Cecil, Shelby Twp., MI (US)

(21) Appl. No.: 13/721,251

(22) Filed: Dec. 20, 2012

Related U.S. Application Data
(63) Continuation-in-part of application No. 29/438,833, filed on Dec. 4, 2012, now Pat. No. D689352.

(51) Int. Cl. B25B 13/48; F16B 23/00; B25B 13/06

(52) U.S. Cl. CPC B25B 13/485; B25B 13/065; F16B 23/0007
USPC 81/121.1; 411/407

(57) ABSTRACT

A tamper resistant fastener system includes a threaded fastener having a head provided with uniquely formed and arranged engagement teeth for engaging with complimentarily formed teeth on a socket style torque transmitting drive tool. Engagement of the respective sets of teeth on application of torque from the drive tool in one direction advances the fastener, but application of torque from the drive tool is not effective in an opposed direction to remove the fastener.

### CROSS-REFERENCE TO RELATED APPLICATION

This application is a continuation-in-part of Design Patent Application No. 29/438,833, filed Dec. 4, 2012, which is hereby incorporated by reference.

### BACKGROUND

The present invention relates to one-way, tightening only, threaded security fasteners, such as nuts, bolts and screws, and a drive system for installing the fasteners.

In many instances it is necessary to prevent unauthorized tampering or disassembly of a product in order to prevent theft, vandalism, etc. While it is practicably speaking nearly impossible to stop a determined, professional thief, most applications of tamper-resistant security fasteners require only that access be made sufficiently difficult to deter or delay the ability to easily remove fasteners using common commercially available fastener tools (e.g., screwdrivers, pliers, wrenches, etc.). Known methods for accomplishing theft/vandalism deterrance involve modifying the head of the fastener so that it can be tightened by turning the threads in one direction but not loosened by turning the threads in the opposite direction. This is accomplished by forming the fastener head so that it will only engage with a specially designed drive tool incorporating a mating drive configuration.

Various types of security fastener designs have been employed for this purpose, and each comes with its own particular advantages and disadvantages. For example, some are designed to require precise amounts of torque to be exerted to properly seat the fastener. These designs often suffer the drawback that they can be over torqued without special installation equipment precisely controlling the amount of torque that can be applied. Others have head configurations that require special manufacturing steps such as machining to cut grooves, etc. into the heads and/or special materials like stainless steel, thereby making the fasteners more expensive to be produced. Some designs require a breakaway fastener feature where the head is designed to be physically detached when torqued beyond the necessary force to fully seat the fastener. These often require special materials like stainless steel, and/or special machining steps in manufacture, and can leave an undesirable sharp exposed surfaced. Yet others are designed so that they can be removable with a specific tool or by a specific removal pressure, but this is a disadvantage if the tool or removal technology is acquired by the thief.

There is a need in certain applications to provide a security fastener system that requires no special installation procedure from that of ordinary fasteners, can be hand assembled without any special torquing procedures being required, can be easily tightened by one person with one hand, does not require a breakaway design, is not designed for removal with a removal tool or technology, and which allows for the drive tool to be used interchangeably with security fastener bolts, screws or nuts. In a further aspect, there is a need for a security fastener system which can employ standard socket wrenches to perform installation, but not removal, of the fasteners. In a yet further aspect, there is a need in the design of the security fasteners for ease of manufacture without special machining steps and/or special materials that increase the expense of the fasteners.

Thus, there is a need for improvement in this field.

#895146_1 2 of 13 Attorney Docket No. 011182000004

SUMMARY The claims, and only the claims, define the invention. The present invention includes various alternate embodiments of novel and unique tamper resistant fasteners and systems for installation of various types of tamper resistant fasteners, such as nuts, bolts, and screws. In one aspect, the tamper resistant fastener system includes a threaded fastener having a head provided with uniquely formed and arranged engagement teeth for engaging with complimentarily formed teeth on a socket style torque transmitting drive tool. Engagement of the respective sets of teeth on application of torque from the drive tool in one direction advances the fastener, but application of torque from the drive tool is not effective in an opposed direction to remove the fastener. Simplicity of the design allows for effective tamper resistant fasteners which can be produced at lower cost and yet also provide for relatively easy fastener installation.

Further forms, objects, features, aspects, benefits, advantages, and embodiments of the present disclosure will become apparent from a detailed description and drawings provided herewith.

### BRIEF DESCRIPTION OF THE DRAWINGS

FIG. 1 is a perspective view of the socket drive tool for a tamper resistnat fastener attached to a conventional ratchet wrench that is depicted in hidden lines.

FIG. 2 is a further perspective view of the drive tool socket shown in FIG. 1.

FIG. 3 is an elevation view of the drive tool socket of FIGS. 1 and 2.

FIG. 4 is an elvation view of a T-nut type tamper resistant fastener.

FIG. 5 is a top view of the head of the T-nut type tamper resistant fastener shown in FIG. 4.

FIG. 6 is a cross-section view taken along lines 6-6 in FIG. 5.

FIG. 7 is an elevation view of the drive tool socket with a bolt or screw type tamper resistant fastener. In this view, the drive tool socket is shown in a position to positively engage the teeth on the head of the tamper resistant fastener in order to install the fastener.

FIG. 8 is a further elevation view of the drive tool socket with a bolt or screw type tamper resistant fastener but with the drive tool socket retracted from the position shown in FIG. 7.

FIG. 9 is an enlarged fragmentary view of a portion of FIG. 8.

FIG. 10 is an enlarged fragmentary view of a portion of FIG. 7.

FIG. 11 is an elevation view of a cone nut type tamper resistant fastener.

### DESCRIPTION OF THE SELECTED EMBODIMENTS

For the purposes of promoting an understanding of the principles of the invention, reference will now be made to the examples, sometimes referred to as embodiments, illustrated and/or described herein. These are intended merely as examples. It will nevertheless be understood that no limitation of the scope of the invention is thereby intended. Such alterations and further modifications in the described processes, systems or devices, any further applications of the principles of the invention as described herein, are contemplated as would normally occur to one skilled in the art to which the invention relates, now and/or in the future in light of this document.

As used in the claims and the specification, the following terms have the following definitions:

“vertical” means substantially parallel to the longitudinal axis of the fastener.

“tamper resistant” means to make tampering more difficult, time-consuming, etc. by either the normal users or by others with physical access, whether or not authorized.

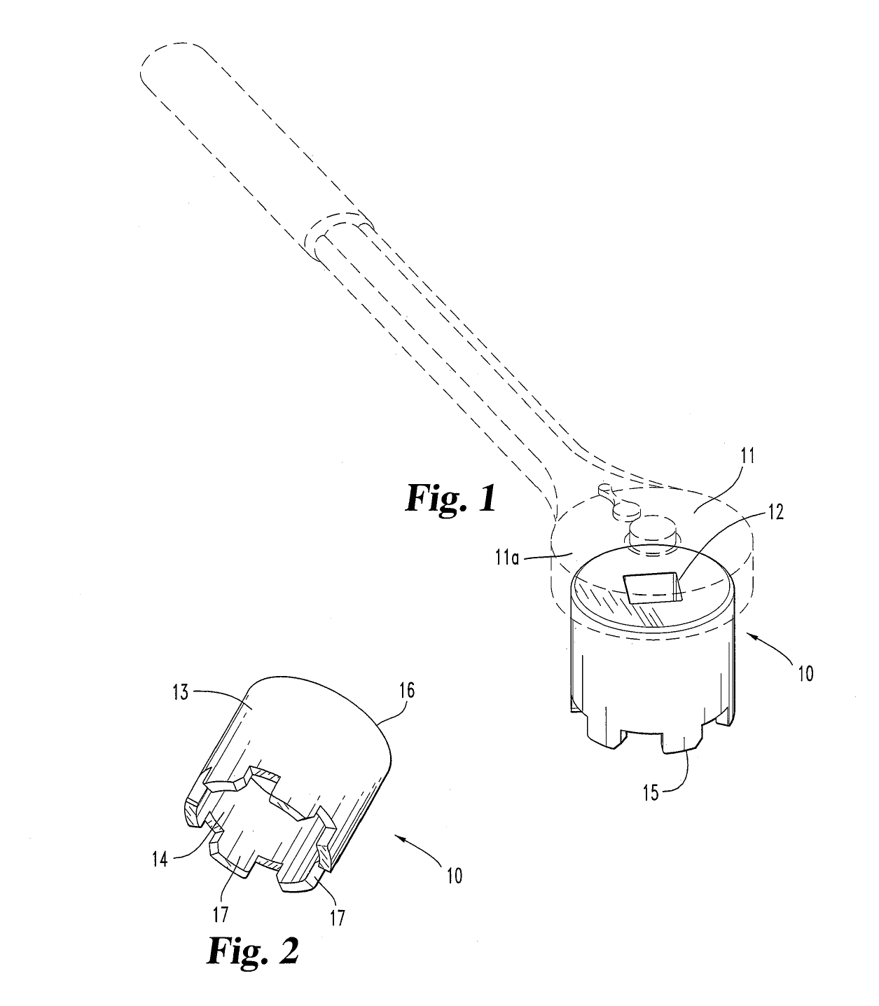

FIG. 1 shows one optional embodiment of drive tool socket 10 is shown attached by way of a square shaped bore 12 to a mating male fitting on torque transmission drive tool 11 which, for purposes of example, is shown illustrated as a ratchet type socket wrench 11a. The ratchet wrench 11a may be of various conventionally known and otherwise suitable designs, it being understood that the drive tool socket 10 does not require a specially designed drive tool, it being a feature of the drive tool socket 10 that it could be modified to work with various manual and power driven drive tools including ratchet wrenches, open face wrenches, impact wrenches, etc. It is also contemplated that there would be a set of differently sized sockets 10 that would be interchangeably attached to the drive tool 11 allowing for use with different sized tamper resistant fasteners. The tamper resistant fasteners may be of different types, including but not limited to nuts, bolts, and screws, and several such types are shown as examples in the drawings including a T-nut type fastener (FIGS. 4-6), bolt and screw type fasteners (FIGS. 7-8), and a cone nut type fastener (FIG. 11). It will therefore be appreciated that the tamper resistant design to be described herein is common to all of them, and common reference numerals are intentionally used where applicable to point out these commonalities.

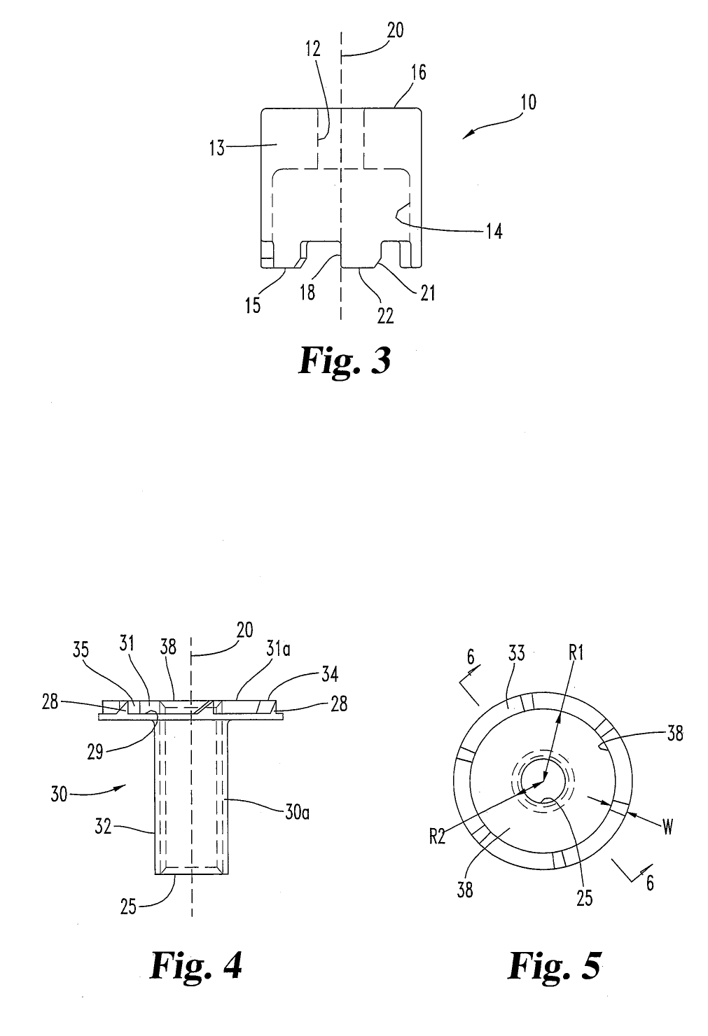

Referring now also to FIGS. 2 and 3, an illustrative embodiment of the drive tool socket 10 is depicted having a generally cylindrically shaped body 13 extending along longitudinal axis 20 between drive end 15 and wrench attachment end 16. In one preferred form, the diameter of socket body 13 is approximately the same size, or only slightly larger than the head of the tamper resistant security fastener. It is contemplated that the body 10 could also have various other shapes as is known and understood in the art. Within the body 13 is a centrally disposed cylindrically shaped recess 14. The shape of recess 14 is also a matter of design choice and may take various other forms. The drive tool socket 10 has a plurality of drive tool teeth 17 formed at drive end 15. In the depicted embodiment, the drive tool socket 10 is provided with six drive teeth 17 although a greater or lesser number could also be employed. In one preferred arrangement depicted, the drive teeth 17 are equally angularly spaced apart around the outer periphery of the socket 10. The configuration of each of the teeth 17 is seen to include a vertically disposed engagement wall 18 extending substantially parallel to longitudinal axis 20 and non-vertically disposed disengagement surfaces 21 and 22. As may be better seen by reference to FIG. 3, the surface 21 is inclined relative to longitudinal axis 20 whereas flat surface 22 is generally transverse to longitudinal axis 20. In one illustrative preferred embodiment, the surface 21 is inclined at an angle of approximately 20-30 degrees relative to the flat surface 22. Although being somewhat less preferred, greater inclinations up to about 45 degrees are also possible. It should further be appreciated that while surfaces 21 and 22 as shown are planar in shape, other contoured surfaces shapes are also contemplated.

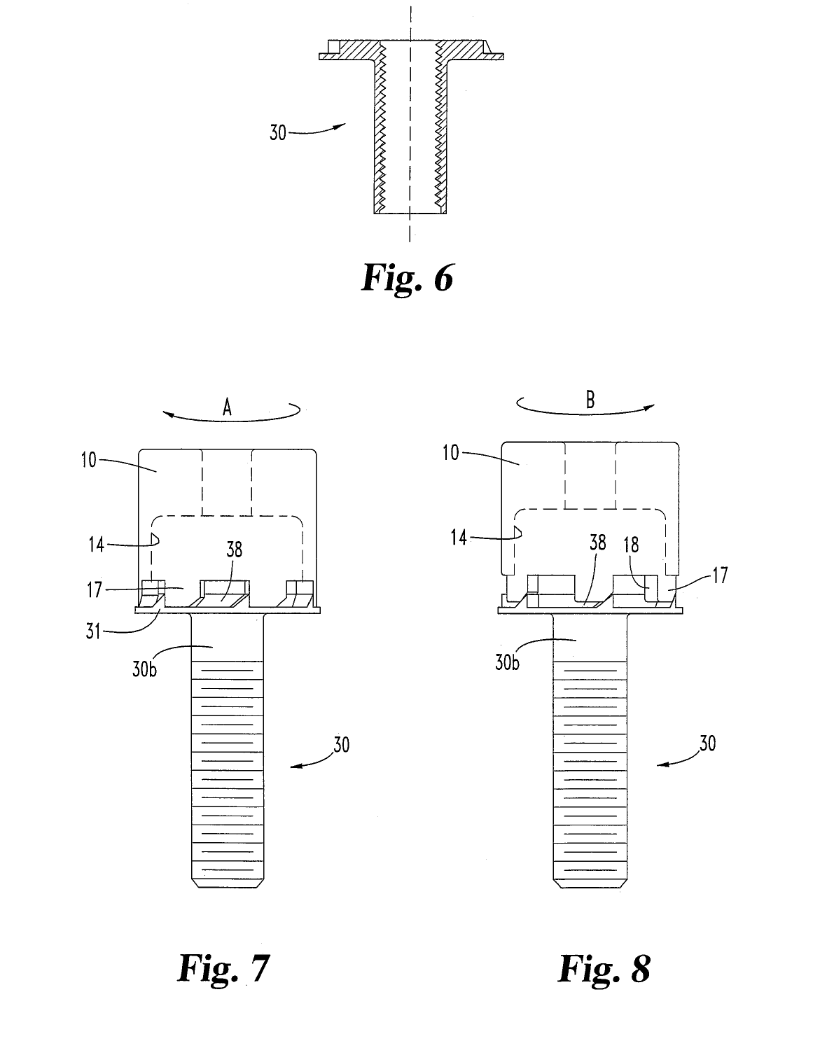

FIGS. 4-6 depict a first optional embodiment of the tamper resistant fastener 30. In this embodiment the fastener 30 is a T-nut type threaded fastener 30a. It may be seen that fastener 30 has an internally threaded bore 25 extending along longitudinal axis 20 through head 31 and shank 32. Head 31 has an outer peripheral portion 33 defining a plurality of angularly spaced teeth 28 separated by recessed surfaces 29 forming complementary engagement surfaces 34 for engagement with teeth 17 on drive tool 11. In one preferred embodiment, the apex 35 of the teeth 17 does not extend substantially above or below the top surface 31a of head 31. Each of the teeth 28 are spaced apart from longitudinal axis 20 a radius “R1” which is a greater distance away from axis 20 than the distance, measured by radius “R2”, of the outer circumference of the threaded shank 32. Engagement surfaces 37 include a vertical engagement wall 35 extending substantially parallel to longitudinal axis 20 and a non-vertical (e.g., inclined) disengagement surface 36. As best seen in FIG. 6, fastener 30 also has an annular shaped tool centering portion 38 that is sized for a close fit with the recess 14 on drive tool socket 10 in order to facilitate alignment and centering of the drive tool 11 on the fastener 30.

In one exemplary embodiment of a ¼ inch sized T-nut fastener 30a having a head diameter of approximately 0.72 to about 0.75 inches, the height of vertical engagement walls 35 of fastener teeth 28 have a height “h” of about 0.045 to about 0.060 inches and a width “w” of about 0.11 to about 0.16 inches, with material of choice being ASTM 563 Grade A carbon and alloy steel. Preferably, in order to maintain a low profile to prevent tampering with conventional tools, the vertical engagement walls of said fastener teeth should be less than about 0.2 inches.

FIG. 11 shows a tamper resistant fastener 30b formed as a cone type nut. As with the T-nut type fastener 30a, cone nut fastener 30b has an outer peripheral portion 33 defining a plurality of angularly spaced teeth 28 separated by recessed surfaces 29 forming complementary engagement surfaces 34 for one way (i.e., drive only) engagement with teeth 17 on drive tool 11.

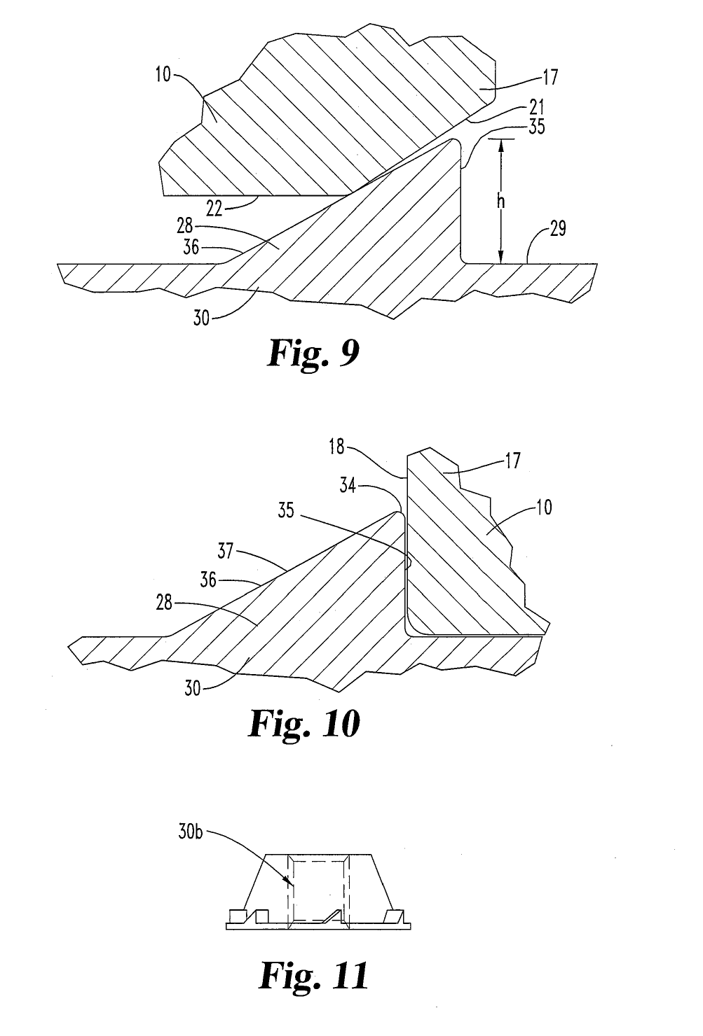

Referring to FIGS. 7-10, the operation of the tamper resistant fastener system will now be described. FIGS. 7 and 8 depict the drive tool socket 10 and tamper resistant fastener 30 in positions of engagement and disengagement such as would occur during clockwise and counterclockwise rotation of the socket 10. The tamper resistant fastener 30 is shown in the form of a right-hand threaded bolt or screw fastener 30c, and therefore clockwise rotation in the direction of arrow “A” in FIG. 7 will result in advancing (i.e., tightening) of the fastener 30 during installation. In order to install tamper resistant fastener 30 into an object to be fastened, the drive tool socket 10 is positioned over the fastener head 31 so that the respective teeth on the socket 10 and fastener 30 align. In this regard, the tool centering portion 38 on the head 31 of the fastener 30 facilitates the centering by virtue of the close fit with the recess 14 in drive tool socket 10. At this point in the operation, the flat surfaces 22 of the drive tool teeth 17 will either come into contact with the fastener teeth 17 (see e.g., as shown in FIGS. 8 and 9) or land on the recessed surfaces 29. In either case, clockwise turning of the drive tool socket will result in the engagement wall 18 of the drive teeth 17 contacting the vertical engagement walls 35 of the teeth 28 on fastener 30 as seen in FIG. 8. With the walls 18 and 35 in engagement, further clockwise rotation of the drive tool will advance the threads until fastener 30 is fully seated. Conversely, it is not possible to use the drive tool socket to remove fastener 30 once installed as counterclockwise rotation in the direction of arrow “B” will only cause the inclined surfaces 21 on the drive teeth 17 to contact the inclined disengagement surfaces 36 of the fastener 30 and cause the drive tool socket 10 to ride upwardly over the fastener teeth 28. Conventional tools such as pliers, screwdrivers, etc. are also ineffective to remove the fasteners 30, and no removal feature is provided on the tamper resistant fasteners 30 to allow removal by a specially designed removal tool. Accordingly, the tamper resistant fasteners 30 are effective to prevent vandalism, theft and or otherwise attempted efforts to disassemble the fastened objects (e.g. security fences and other assembled structures).

While the invention has been illustrated and described in detail in the drawings and foregoing description, the same is to be considered as illustrative and not restrictive in character, it being understood that only the preferred embodiment has been shown and described and that all changes, equivalents, and modifications that come within the spirit of the inventions defined by following claims are desired to be protected. All publications, patents, and patent applications cited in this specification are herein incorporated by reference as if each individual publication, patent, or patent application were specifically and individually indicated to be incorporated by reference and set forth in its entirety herein.

1. A tamper resistant fastener system for one way installation of a fastener, comprising:
a fastener defining a longitudinal axis and having a head and a threaded portion defining a plurality of threads, said head having a plurality of angularly spaced apart fastener teeth extending around the outer periphery of said head remote from said longitudinal axis at a greater distance than said threads, each of said fastener teeth having a vertical engagement wall extending substantially parallel to said longitudinal axis and a non-vertical disengagement surface; and
a torque transmitting drive tool (having a head and a socket) for driving said fastener, said torque transmitting drive tool having a drive end and a wrench attachment end, said drive tool further having a plurality of drive tool teeth formed at said drive end for engaging said vertical engagement walls of said engagement teeth, whereby on application of torque in a first direction said drive tool teeth engage said fastener engagement teeth and advance said threads, and whereby application of torque with said drive tool in an opposed direction causes said drive teeth to contact said non-vertical disengagement surfaces and is not effective to turn said threads so as to to remove said fastener.

2. The tamper resistant fastener system of claim 1 wherein said drive tool has a recess in said drive end and head of said fastener has a tool centering portion that aligns with said recess.

3. The tamper resistant fastener system of claim 1 wherein said torque transmitting drive tool is a socket adapted for attachment to a socket wrench, said drive tool socket having a generally cylindrical shaped socket body, and wherein the diameter of said socket body is not substantially greater than said fastener head.

4. The tamper resistant fastener system of claim 1 wherein said fastener teeth and said drive tool teeth are equally angularly spaced apart around said longitudinal axis.

5. The tamper resistant fastener system of claim 2 wherein said fastener includes six fastener teeth.

6. The tamper resistant fastener system of claim 1 wherein the height of said vertical engagement walls of said fastener teeth is less than about 0.1 inches.

7. The tamper resistant fastener system of claim 5 wherein the width of said vertical engagement walls of said fastener teeth is less than about 0.2 inches.

8. The tamper resistant fastener system of claim 1 wherein said non-vertical disengagement surface of said fastener teeth includes an inclined surface portion having an inclination less than about 45 degrees.

9. The tamper resistant fastener system of claim 1 wherein said non-vertical disengagement surface of said teeth has an inclined surface portion having an inclination less than about 30 degrees.

10. The tamper resistant fastener system of claim 1 wherein said torque transmitting drive tool is a one-way drive tool that cannot also be used to remove said fastener from the workpiece.

11. The tamper resistant fastener system of claim 1 wherein said fastener may be either a nut, bolt, or screw type fastener.

12. A tamper resistant fastener system for one way installation of a, comprising:
a fastener defining a longitudinal axis, said fastener having a head and a threaded shank extending along said axis, said threaded shank defining a plurality of threads, said head having an outer portion defining a plurality of engagement surfaces, said engagement surfaces spaced apart from said longitudinal axis a greater distance than said threads, said engagement surfaces having a vertical engagement wall extending substantially parallel to said longitudinal axis and a non-vertical disengagement surface; and
a torque transmitting drive tool for driving said fastener, said tool having a plurality of drive teeth for engaging said vertical engagement walls on said outer portion of said head, whereby application of torque in a first direction allows said fastener to rotate so as to advance said threads and whereby application of torque is not effective in an opposed direction to turn said threads so as to to remove said fastener.

13. A drive tool for installing one way tamper resistant fasteners, comprising:
a socket body having a fastener engaging end; and
a drive portion, said drive portion being configured for removable attachment to a wrench;
said socket body having a cylindrical outer shape and centrally disposed cylindrical recess defining a cylindrical wall, said wall having a plurality of angularly spaced apart teeth extending axially from said wall, and wherein the outer diameter of said socket body is not substantially greater than the outer diameter of said fastener head.

14. A tamper resistant security fastener, comprising:
a head portion; and
a threaded shank portion defining a plurality of fastening threads extending along the longitudinal axis of said fastener, said head portion having a plurality of one way drive teeth postioned at the outer periphery of said head portion and equally angularly spaced apart, said drive teeth having a drive tool engagement wall extending parallel to the longitudinal axis of said fastener and an inclined wall providing a drive tool disengagement surface.

15. The tamper resistant security fastener of claim 14 wherein said fastener is one of a nut, bolt, and screw.

16. The tamper resistant security fastener of claim 14 wheren said head portion includes six one-way drive teeth.

17. The tamper resistant security fastener of claim 14 wheren said inclined wall of said drive teeth have an inclination less than about 30 degrees, the height of said drive tool engagement walls of said drive teeth is less than about 0.1 inches and the width of said drive tool engagement walls of said drive teeth is less than about 0.2 inches.
